(19) United States
(12) Patent Application Publication
(10) Pub. No.: US 2023/0223511 A1
(43) Pub. Date: Jul. 13, 2023

(54) APPLICATION OF STRUCTURAL ENERGY STORAGE WITH CARBON FIBER IN PERSONAL WEARABLE AND CARRIABLE DEVICES

(71) Applicant: TOYOTA MOTOR ENGINEERING & MANUFACTURING NORTH AMERICA, INC., Plano, TX (US)

(72) Inventors: Jae Seung LEE, Ann Arbor, MI (US); Paul GILMORE, Ann Arbor, MI (US)

(73) Assignee: TOYOTA MOTOR ENGINEERING & MANUFACTURING NORTH AMERICA, INC., Plano, TX (US)

(21) Appl. No.: 17/574,642

(22) Filed: Jan. 13, 2022

(51) Int. Cl. H01M 4/133; H04R 1/08; H04R 3/00; G10K 11/178; H04N 5/225; G06F 3/041

(52) U.S. Cl. CPC H01M 4/133; G06F 3/041; G10K 11/1787; H04N 5/2257; H04R 1/08; H04R 3/00; H01M 2004/027

(57) ABSTRACT

An electric power storage device, including a protective cover configured to protect from impact and including an electric carbon fiber component, the electric carbon fiber component incorporating a structural battery, the structural battery including energy storage devices. The energy storage devices are suitable for energy storage and structural support for the electric carbon fiber component. Each of the energy storage devices having an anode core of a continuous carbon fiber, an electrolyte arranged on the continuous carbon fiber core, and a cathode layer arranged to the at least one continuous carbon fiber core on the electrolyte, and an interface terminal electrically connected to the structural battery, the interface terminal for outputting power from the structural battery.

### CROSS-REFERENCE TO RELATED APPLICATIONS

This application is related to non-provisional application no. 17/372,629 filed Jul. 12, 2021, the entire contents of which are incorporated herein by reference.

This patent application is also related to non-provisional application attorney docket no. 538559US, filed Jan. 13, 2022, entitled “STRUCTURAL ENERGY STORAGE WITH CARBON FIBER FOR SPORT EQUIPMENT SENSOR” which is filed concurrently herewith, the entire contents of which are incorporated herein by reference.

This patent application is also related to non-provisional application attorney docket no. 538560US, filed Jan. 13, 2022, entitled “STRUCTURAL ENERGY STORAGE FOR CF BASED PERSONAL MOBILITY AND LIGHTWEIGHT DELIVERY” which is filed concurrently herewith, the entire contents of which are incorporated herein by reference.

This patent application is also related to non-provisional application attorney docket no. 538561US, filed Jan. 13, 2022, entitled “STRUCTURAL ENERGY STORAGE FOR CF BASED POWERED MOBILE DEVICES” which is filed concurrently herewith, the entire contents of which are incorporated herein by reference.

### FIELD OF THE DISCLOSURE

This disclosure is directed to structural energy storage devices, containing a plurality of lithium ion batteries having an anode of a continuous carbon fiber core, applied to personal wearable devices in order to compensate for weight, space and location of conventional batteries.

### DISCUSSION OF THE BACKGROUND

Carbon fiber (CF) has been an emerging material in personal safety and wearable equipment because of its light weight and strong mechanical property, including battery powered personal safety equipment, augmented reality and virtual reality headsets, wireless headphone, mobile devices, and personal protection equipment. These personal safety and wearable equipment may be categorized based on applications of carbon fiber as a composite battery.

One category of application is a carbon fiber material in personal safety equipment having a protective cover, such as a safety helmet. The demand for lighter weight for personal safety equipment such as helmets in sports and industrial applications has been increasing. In competitive and high-end cycling, minimizing even a little weight is top priority. For modern motorcycle and ski, more electronics functions are added on top of the weight priority. For example, helmets are equipped with microphone, speaker, Bluetooth connection, light, emergency call, head up display and so on. For a hardhat for industrial usage, reducing weight of the hardhat becomes an attractive approach to reduce ergonomic stress, while adding more smart functions.

FIGS. 1A, 1B, 1C, 1D illustrate examples of conventional carbon fiber helmets. For high-end cycling where minimum weight and aerodynamic design becomes an important aspect of performance, CF has been in the mainstream market (FIG. 1A. Recently bike helmets 102 have adopted more electronic functions such as camera, light (LED light), and in some products display in windshields. For an advanced skier and motorcycle rider, more electric devices are being integrated into ski helmets 104 and motorcycle helmets 106. However, the addition of a battery adds more weight and disturbs the weight balance depending on the location of a battery. CF has become a popular option of material for a hardhat 108 in industrial applications. Integration of electronic features onto those helmets is a current trend, and can include a motion camera, microphone, Bluetooth connection, and lighting.

A second category of application of augmented reality (AR), virtual reality (VR), mixed reality (MR) headsets have become popular in gaming, entertainment, and industrial applications. Due to its mobility, electronics components are solely relying on a built-in battery. The built-in battery can be a big and heavy part within the frame of smart glasses 202. A smart helmet 204 which is specialized more in industrial applications including virtual display in factory, complex training in virtual format, virtually interactive interface is another application area. A wireless headphone 206 and earbuds are in similar demand.

For personal electronic devices such as laptop, smartphone, tablet, tablet cover, stylus pen, smart watch, smart wallet, remote control, digital camera wherever the device operates in mobile and requires lighter weight can benefit from lighter weight batteries. Depending on specification, the percentage varies, but weight and volume of a battery is a significant part in this category of applications. For example, a battery makes up about 50% of total weight and substantial volume percentage in most smart watches 302. In a typical tablet 304, a battery makes up about 32% of its total weight. In Macbook air 306, a battery makes up about 20% of total weight.

FIGS. 2A-2C illustrate examples of smart vision, including smart glasses, smart helmet, wireless headphone. Each smart vision application requires a battery pack that is as large as possible in order to power computer processing and sensors, and maximize time of use between charges. FIGS. 3A-3C illustrate examples of battery powered mobile devices. As in FIG. 3A, a smartwatch battery 312 can make up 50% of the total weight, and a substantial volume percent. As in FIG. 3B, a battery 314 in a tablet computer can make up 32% of the total weight. As in FIG. 3C, a battery 316 in a laptop computer can make up 20% of the total weight.

A third category of application is personal protection equipment, for military or law enforcement use. As military equipment becomes more advanced, infantry carry a number of electronic devices for example, radio, lighting, vision, and navigation. For a typical 72 hour mission, soldiers currently carry an average of about 20 pounds of batteries.

FIGS. 4A- 4F illustrate examples of military armor and military devices. Batteries are needed for military devices including portable radio 402 (FIGS. 4A, 4B), flashlight 404 (FIG. 4C), and night vision gear 408 (FIG. 4E). Also, military armor 406 (FIG. 4D), as well as military helmets 410 (FIG. 4F) having built-in military devices, may include components/material made of carbon fiber.

Each of these categories of application may use the carbon fiber composite as structure for reduced weight. However, these categories of application use batteries as a power source, which take up valuable space and can add substantial weight.

### SUMMARY OF THE DISCLOSURE

An aspect is an electric power storage device that can include a protective cover configured to protect from impact including at least one electric carbon fiber component, the at least one electric carbon fiber component incorporating a structural battery, the structural battery including one or more energy storage devices; each of the one or more energy storage devices having, at least one anode core of a continuous carbon fiber, an electrolyte arranged on the at least one continuous carbon fiber core, and a cathode layer coating arranged to the at least one continuous carbon fiber core on the electrolyte, and at least one interface terminal electrically connected to the structural battery, the at least one interface terminal for outputting power from the structural battery.

A further aspect is an electric power storage device that can include a head mountable frame including at least one electric carbon fiber component, the at least one electric carbon fiber component incorporating a structural battery, the structural battery including one or more energy storage devices, each of the one or more energy storage devices having at least one anode core of a continuous carbon fiber, an electrolyte arranged on the at least one continuous carbon fiber core, and a cathode layer coating coaxially arranged to the at least one continuous carbon fiber core on the electrolyte coating, a vision system mounted in the frame and having at least one sensor, and at least one interface terminal electrically connected to the structural battery, the at least one interface terminal connected to the at least one sensor for powering the at least one sensor by the structural battery.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A, 1B, 1C, 1D illustrate examples of conventional carbon fiber personal safety equipment.

FIGS. 2A, 2B, 2C illustrate examples of conventional audio-vision devices.

FIGS. 3A, 3B, 3C illustrate examples of battery operated mobile devices.

FIGS. 4A, 4B, 4C, 4D, 4E, 4F illustrate examples of military devices and armor that can include carbon fiber.

FIG. 5 shows a schematic drawing of a structural arrangement of coaxial energy storage devices in a shell according to an embodiment of the disclosure.

FIG. 6 shows another schematic drawing of a structural arrangement of coaxial energy storage devices in a shell according to an embodiment of the disclosure.

FIG. 7 shows a schematic drawing of a structural arrangement 700 of laminate energy storage devices between shell layers.

FIG. 8 shows a schematic drawing of a structural arrangement of laminate energy storage devices with carbon fibers.

FIGS. 9A, 9B illustrate steps in forming a carbon fiber mat into a shape.

FIGS. 10A, 10B is a schematic of a connection structure for a structural CF battery.

FIG. 11 is a schematic of a structural CF battery arranged as a sublayer.

FIG. 12 is a schematic of a cycling helmet according to an embodiment of the disclosure.

FIG. 13 is a system for a cycling helmet according to an embodiment of the disclosure.

FIG. 14 illustrates a carbon fiber skiing helmet according to an embodiment of the disclosure.

FIGS. 15A, 15B illustrates carbon fiber motorcycle helmet according to an embodiment of the disclosure.

FIG. 16 illustrates a carbon fiber safety helmet according to an embodiment of the disclosure.

FIGS. 17A, 17B are a schematic of smart glasses according to an embodiment of the disclosure.

FIG. 18 is a breakout view of smart helmet according to an embodiment of the disclosure.

FIG. 19 is a schematic of the interior of a smart helmet according to an embodiment of the disclosure.

FIG. 20 illustrates location of cameras for a smart helmet according to an embodiment of the disclosure.

FIG. 21 is a schematic of a wireless headphone according to an embodiment of the disclosure.

FIGS. 22A, 22B, 22C, 22D are exemplary battery operated mobile devices that can include carbon fiber batteries.

FIGS. 23A to 23F are examples of military devices and armor that can include carbon fiber batteries.

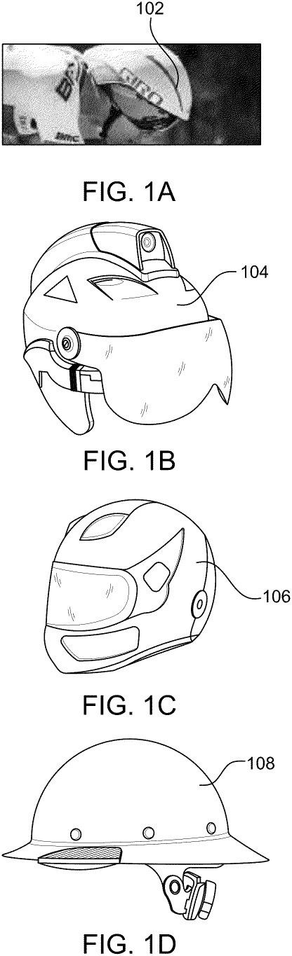

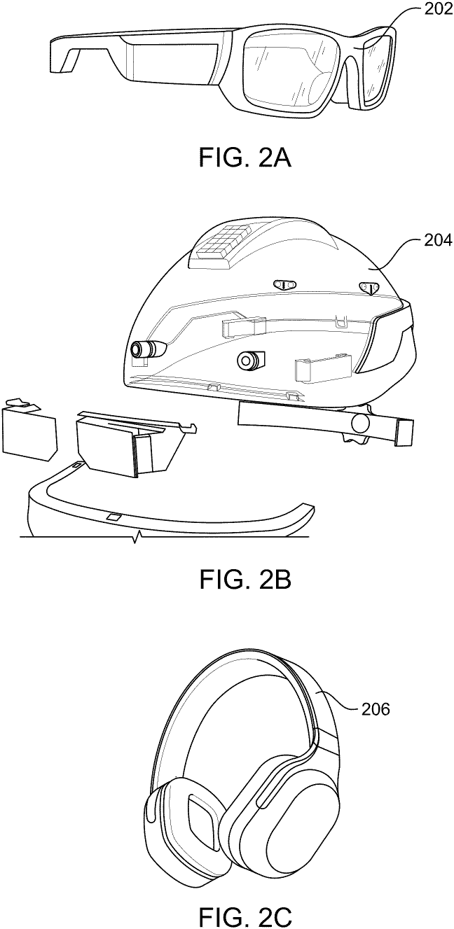

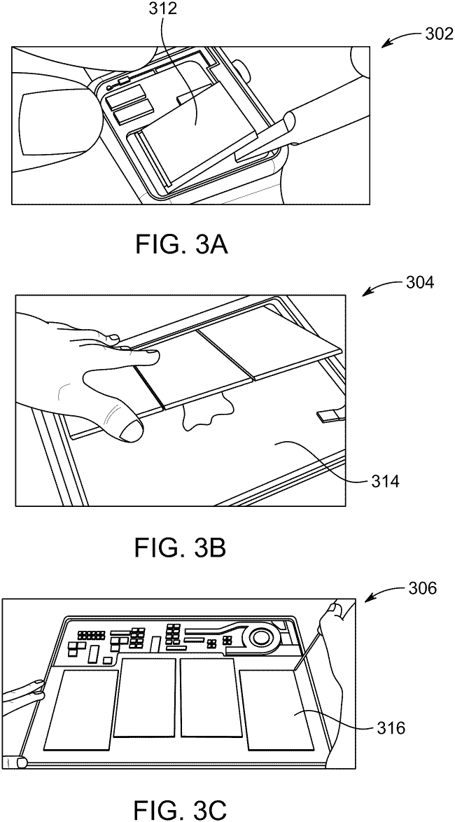

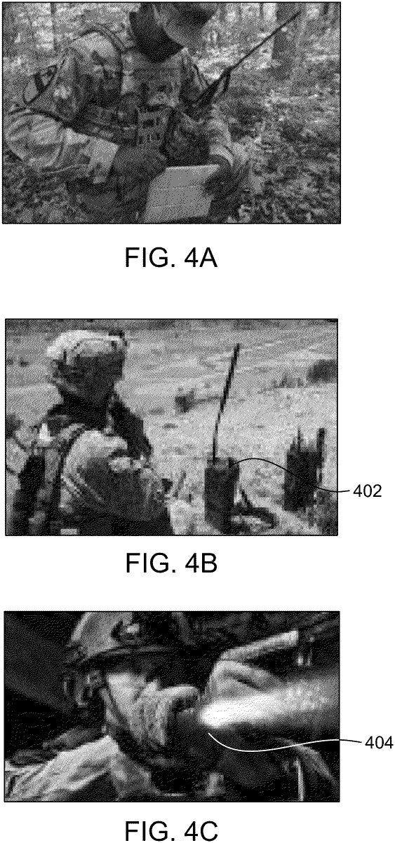

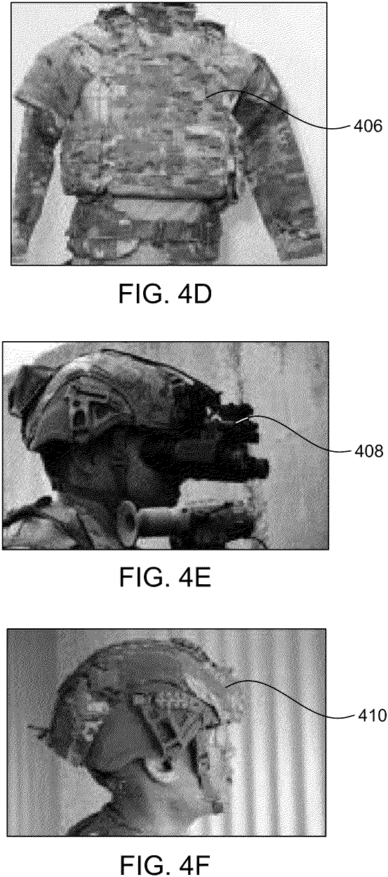

### DETAILED DESCRIPTION OF THE PREFERRED EMBODIMENTS

As used herein, the words “a” and “an” and the like carry the meaning of “one or more.” The phrases “selected from the group consisting of,” “chosen from,” and the like include mixtures of the specified materials. Terms such as “contain(s)” and the like are open terms meaning ‘including at least’ unless otherwise specifically noted. All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

It is highly desired that personal safety and wearable equipment be of as light weight as possible, while having high strength. However, a battery and battery enclosure takes up valuable space, and longer battery operation and higher power require a larger battery. Also, the location of the battery and battery enclosure is restricted based on available dimensions and location of other components. In addition, many batteries must be removed in order to be recharged or replaced. On the other hand, internal batteries for mobile devices, such as smart watches, smartphones, tablet computers, or laptop computers, can be recharged by way of a power input connector. Presently, most smartphones and tablet computers are capable of being recharged by way of a standard USB connection. Laptop computers typically require battery packs (power supplies) with greater power than can be supplied with a regular USB connection, and can vary depending on how the laptop is configured.

Disclosed embodiments relate to a structural energy storage formed in CF to supply electricity which facilitates various added features, devices, or sensors either embedded in or attached on devices for personal safety, audio-visual, mobile devices, and lightweight military equipment. The electricity can be used to operate embedded sensors, support actuation, heat or cool etc. The inventors recognized that a structural battery employing a carbon fiber core anode can bring about a power source without much increase in size and weight. In an ideal case, if the structural battery has the same energy density and stiffness as a conventional battery and structure respectively, the mass of an added feature, motor, sensor unit may be reduced by as much as 25-35%. However, even if the ideal is not achieved, significant weight savings would still be possible depending on the structural mass efficiency and structural energy efficiency attained with the device. Moreover, the structural battery employing a carbon fiber core anode may be extended to a wide range of utilities by providing energy storage in addition to structural form and support of carbon fiber composite materials.

The structural battery includes two main components:

1. A mechanically compliant electrolyte coated onto the carbon fiber that acts as a mechanical buffer layer between the carbon fiber and cathode while simultaneously conducting lithium ions.

2. A composite cathode designed to have a very low volume expansion by embedding active material particles in a conductive polymer matrix.

The mechanically compliant electrolyte may have low stiffness but provides good adhesion to the anode and cathode.

In some embodiments, a structural battery may include one or more coaxial arranged CF energy storage devices. A coaxial arranged CF energy storage device may be prepared by first coating a continuous carbon fiber with an electrolyte precursor coating solution containing a lithium salt, a polymer or monomer which solvates lithium ion, a gel or elastomer matrix polymer or oligomer, a UV sensitive cross-linking agent, a photoinitiator and a plasticizer. The polymer or monomer which solvates lithium ion and the gel or elastomer matrix polymer or oligomer may be the same material and correspond to the polymers used for the electrolyte or the precursors thereof.

The lithium salt provided in the gel or elastomer of the electrolyte coating comprises at least one selected from the group consisting of LiTFSI, LiBF₄, LiPF₆, LiClO₄, LiCF₃SO₃, LiCl and LiAsF₆. Combinations of these may be employed and other additives to enhance lithium ion conductivity may be included.

Conventionally known photoinitiators compatible with the polymer and/or oligomer are employed and may include but are not limited to any of aminoacetophenones, phosphine oxides, benzophenones, benzyl formates and thioxanthones. Such photoinitiators are commercially available.

The cross-linking agent employed is determined by the polymer of oligomer structure and is well known to one of skill in the art.

The electrolyte material composition is dissolved in a carbonate solvent or ether solvent system and my then be applied to the continuous carbon fiber by any suitable coating method which applies a uniform and complete coating to the entire carbon fiber surface. In one embodiment, in preparing the electrolyte coating composition it may be necessary to prepare a composition which forms a contact angle on the carbon fiber surface of 100° or less. The lower the contact angle the thinner the coating that can be applied to the carbon fiber. The contact angle may be controlled by selection of solvent and plasticizer, concentration of the lithium salt and polymer, and temperature. In one embodiment, the electrolyte may also be coated onto the carbon fibers using vacuum bagging or vacuum infusion technique. The electrolyte precursor solution can be infiltrated into the carbon fiber.

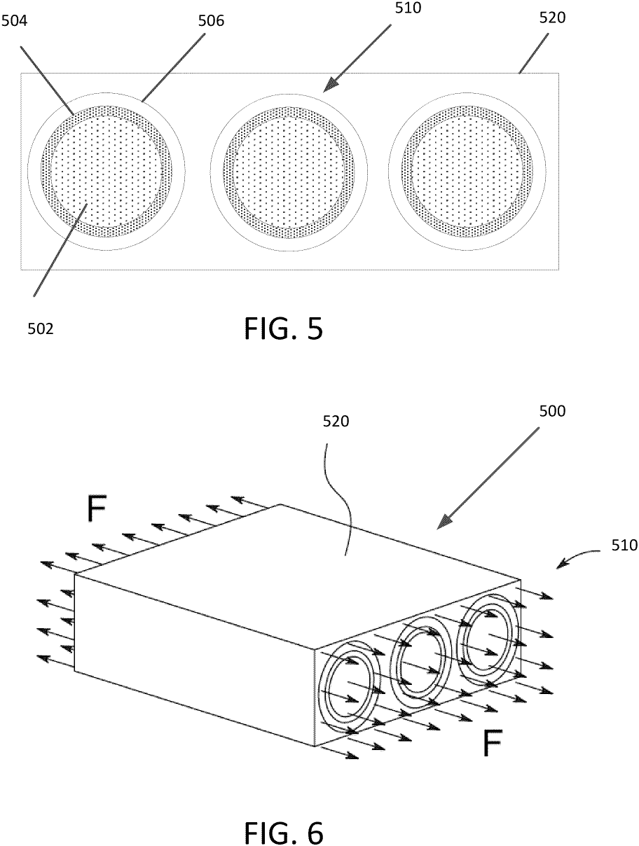

FIG. 5 shows a schematic drawing of a structural arrangement of coaxial energy storage devices in a shell according to an embodiment of the disclosure. Once the electrolyte coating 504 is applied to the continuous carbon fiber 502, it is exposed to UV irradiation to cure the polymer matrix coaxially arranged about the carbon fiber which is now the core of the device. The solvent remains in order to obtain the elastic electrolyte coating layer.

Next the cathode coating 506 is applied to the surface of the elastic electrolyte coating 604.

A plurality of the coaxial energy storage device 510 (coaxially arranged CF battery) is arranged within a shaped composite battery structure 500 having a shell 520 or outer coating and an inner matrix enclosed by the shell. The matrix encloses the plurality of coaxial energy storage devices 510.

Once the electrolyte and cathode layers are coated onto the carbon fibers, the coaxial energy storage devices 510 are arranged within a shell 520 having a structure and are subsequently impregnated with a matrix material as schematically represented in FIG. 6 The composite battery structure 500 (referred to herein as a coaxial arranged carbon fiber battery, or simply coaxially arranged battery) schematically represented in FIG. 6 with embedded energy storage can be formed to perform in a wide variety of structural applications while providing electrical power to devices requiring energy or supplementing the energy requirement of the device.

The shell 520 may be composed of a metal and/or a fiber reinforced plastic. Materials employed for such sandwich shell matrix composites are conventionally known for example in the construction of airplane components, automobile components, protective equipment and other vehicles for transportation and sport. In particular, the matrix enclosed by the shell 520 may comprise a resin selected from the group consisting of (meth) acrylate resins, epoxy resins, diallyl phthalate resins and phenolic resins.

The coaxial energy storage devices 510 may be arranged within the composite structure (coaxially arranged CF battery 500) in any arrangement. For example, unidirectionally and in parallel, in a mat arrangement wherein the coaxial energy storage device are oriented both in weft and warp orientations or in only one of weft and warp while the other direction is occupied by a structural fiber such as a glass fiber, a carbon fiber or an aramid fiber.

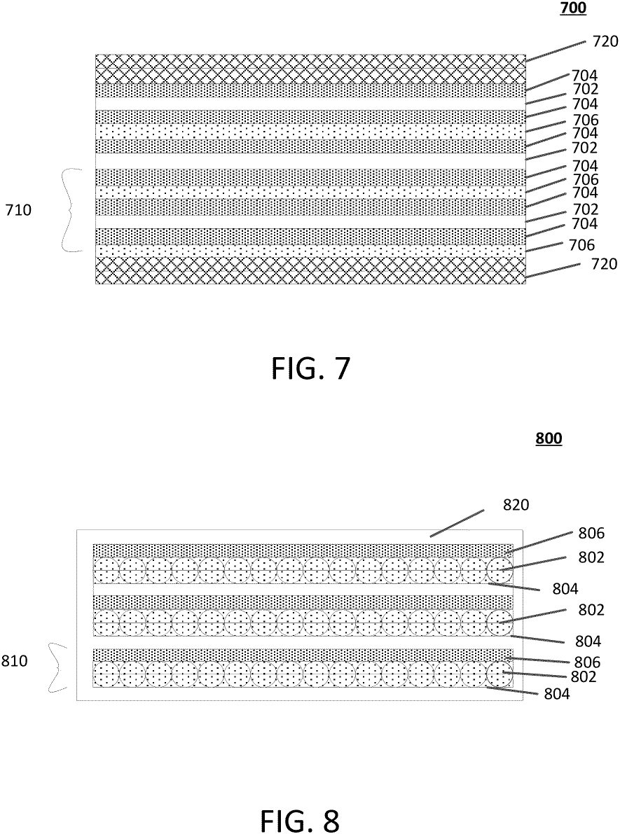

In some embodiments, a structural battery may include structural laminate energy storage devices. FIG. 7 shows a schematic drawing of a structural arrangement 700 of laminate energy storage devices between shell layers. An electrolyte layer 704 is applied to a continuous carbon layer 702 and is exposed to UV irradiation to cure the polymer matrix arranged on the carbon layer. The solvent remains in order to obtain the elastic electrolyte coating layer.

Next a cathode layer 706 is applied to a surface of the electrolyte layer 704 to forma a laminate energy storage device 710.

A plurality of the laminate storage device 710 is arranged within a shaped composite structure having a shell layer 720 or outer coating and an inner matrix enclosed by the shell. The matrix encloses the plurality of laminate energy storage devices 710.

In some embodiments, a structural battery may include structural energy storage devices in which a carbon layer is a plurality of carbon fibers 802. FIG. 8 shows a schematic drawing of a structural arrangement of laminate energy storage devices with carbon fibers. Once an electrolyte coating 804 is applied to the continuous carbon fibers 802, it is exposed to UV irradiation to cure the polymer matrix coaxially arranged about the carbon fiber which is now the core of the device. The solvent remains in order to obtain the elastic electrolyte coating. A cathode layer 806 is applied to a surface of the electrolyte coating 804 to form a laminate energy storage device 810. A plurality of the laminate storage device 810 is arranged within a shaped composite structure having a shell layer 820 or outer coating and an inner matrix enclosed by the shell. The matrix encloses the plurality of laminate energy storage devices 810.

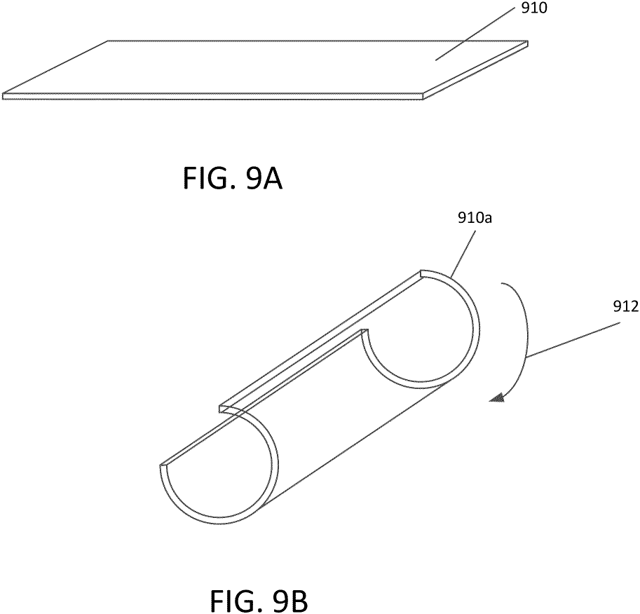

In manufacturing, the Carbon Fiber composite battery structure can be made into a mat arrangement, shaped into a desired shape, and cured. FIGS. 9A, 9B illustrate steps in forming a carbon fiber mat into a shape.

FIG. 9A shows where the carbon fiber composite structure is in a mat arrangement 910. FIG. 9B shows where the mat is formed 912 into a shape 910a. When the desired shape is obtained, the final shape 910a is cured. Although the shape shown in FIG. 9B is curved, the mat 910 in FIG. 9A may be folded at one or more creases to form various shapes, such as rectangular-like cross-section shapes, oval-like cross-section shapes, to name a few.

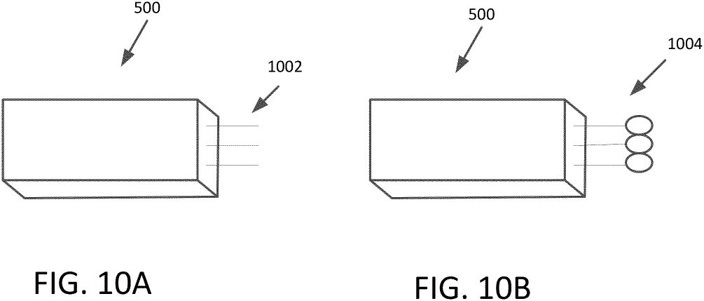

FIGS. 10A, 10B is a schematic of a connection structure for a structural CF battery. Connection to the structural CF battery 500 may be by a wired connection 1002 or a wireless connection 1004. In the case of a wired connection 1002, the structural CF battery 500 may include wire terminals extending from an end of the composite structure 500. In the case of a wireless connection 1004, the structural CF battery 500 may include one or more coils at an end of the composite structure. In addition, the structural CF battery may be configured with a charge unit that may be connected by the wired connection 802 or the wireless connection 1004.

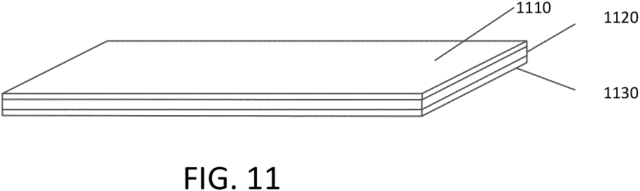

FIG. 11 is a schematic of a structural CF battery arranged as a sublayer. Some embodiments may include a protective cover 1110 with the structural CF battery 11920 arranged as a sublayer. In addition, the structural CF battery 1120 may be sandwiched between the protective cover 1110 and an optional lower support layer 1130. The protective cover 1110 may be a carbon fiber shell, a fiber reinforced plastic, or carbon fiber reinforced resin. In some embodiments, the protective cover 1110 may be of the same material as the shell 520 of the structural CF battery. The support layer 1130 may also be of the same material as the shell 520 of the structural CF battery.

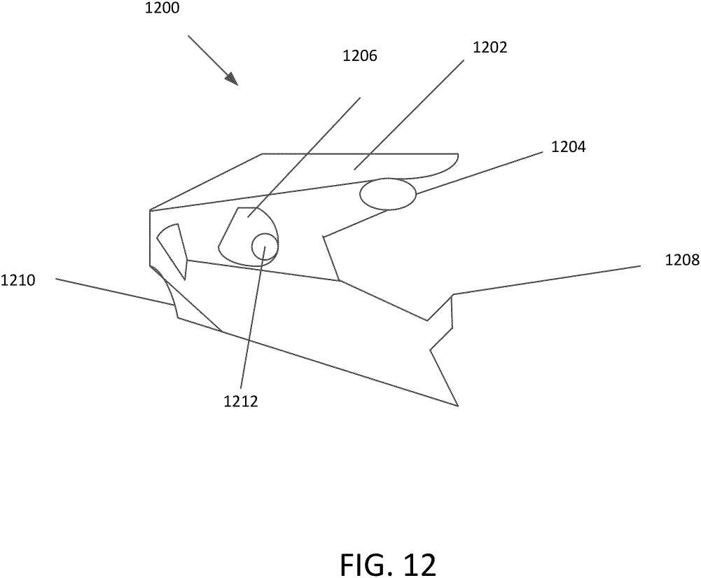

FIG. 12 is a schematic of a cycling helmet according to an embodiment of the disclosure. The primary function of a cycling helmet is for personal protection at the lightest weight. Cyclists often depend on separate electronic components, such as a camera, GPS device, performance measurement device, lighting that can be attached to a bike handlebar seat post, cyclist’s body, or top or side of a helmet. Each electronic component requires its own battery. It is not desirable to incorporate several of these electronic components into a helmet, each requiring a dedicated battery. For example, attachment of both a light and a camera to a cycling helmet results in added weight that may lead to fatigue in neck muscles and instability in maintaining the helmet in place on a cyclist’s head. The rechargeable battery in a bicycle light is typically heavy, and the brighter the light the heavier the battery. Video cameras that can be mounted on a helmet of cyclist’s body preferably have long battery life for long recording time. As mentioned above, some cycling helmets integrate electronic functions such as camera, light (LED light), and even display in windshields. Still, in order to increase the battery life for electronic functions, the electronic device will require a heavier battery.

Configuring all or a portion of carbon fiber in the shell of a helmet as a structural CF battery can enable electronic components to be added to a cyclist safety helmet without the extra weight and placement restrictions of internal batteries.

The shell of the helmet may be a protective cover configured to protect from impact and penetration. The performance criteria for head protection is generally provided in ANSI Z89.1 American National Standard for Industrial Head Protection. A helmet may be configured to reduce the force of impact resulting from a blow to the top of the head. A helmet may be configured to reduce the force of impact resulting from a blow to the top, front, back, and sides of the head.

Referring to FIG. 12, the carbon fiber shell 1202 of a cyclist’s helmet 1200 may be configured with a structural CF battery. In some embodiments, one or more sections of the carbon fiber shell 1202 may be configured with separate CF batteries, sized to provide power for certain electronic components. In some embodiments, the structural CF battery may be arranged as a sublayer below a protective cover 1110. The protective cover 1110 may be the carbon fiber shell 1202, or a fiber reinforced plastic. In some embodiments, there may be several structural CF batteries of a predetermined size, or sizes, and interconnected in series or parallel to provide a required voltage or current.

One or more video cameras 1204 may be incorporated, for example, into an upper forward portion of the helmet 1200. Also, a microphone 1208 may be incorporated in a portion of the helmet 1200 that is proximate to a cyclist’s mouth. One or more speakers 1212 may be incorporated inside of the shell 1202 to provide a sound output. A processing module 1206, may include a communication module, such as Bluetooth and/or WiFi, and may be incorporated into a side portion of the helmet 1200.

One or more electrical connection ports 1210 may be included in the one or more sections of the carbon fiber shell 1202 that are configured as structural CF batteries. The connection ports 1210 are connected to wired terminals 802 of respective sections of the structural CF battery. The connection ports 1210 may be USB or micro USB ports. In one or more embodiments, a single connection port 1210 may be included for recharging the structural CF battery. The structural CF battery may include multiple wired terminals 1002 for connection to one or more sensor devices.

Some types of sensors may be incorporated into the cycling helmet 1200 that normally may have been prohibitive due to the requirement for additional batteries. Sensors may be directly wired to a terminal 1002 of a structural CF battery without having to add a battery housing and a battery for powering the sensor. Additional sensors that may be incorporated into the helmet 1200 may include a proximity sensor that detects when the helmet is being worn on the cyclists head, or has been removed, and an accelerometer that can detect motion of the helmet 1200. The sensors may be connected to a processor (in processing module 1206) that is configured to determine an abrupt motion of the helmet 1200 while it is being worn on the head of the cyclist. An abrupt motion of the helmet 1200 may be a sudden acceleration of the helmet 1200 followed by an abrupt stop in movement and/or a sudden reversal in direction of movement. The detection of an abrupt motion may be an indication of a possible collision or fall. The processor may be configured to send out a signal in the case of the indication of the possible collision or fall.

In one embodiment, the video camera 1204 may be connected to the processor (in processing module 1206), which may control turning on and off the video camera in conjunction with the proximity sensor detecting that the helmet 1200 is on or off the cyclist’s head.

The communication unit (in processing module 1206) may be connected to at least one speaker and configured to communicate with wireless performance measurement devices. Performance measurement information may be provided in the form of a speech output to the cyclist through the at least one speaker. The at least one speaker may be directly wired to a terminal 1002 of a structural CF battery.

In one embodiment, an internal battery (e.g., lithium polymer battery or lithium ion battery) of the helmet 1200 may use a structural CF battery to provide supplemental power for additional sensors, cameras, etc. Alternatively, the structural CF battery may provide backup power for an internal battery of the helmet 1200. For example, the output power of the structural CF battery may be used as backup power when a lithium polymer battery reaches a state of charge that is at or below a predetermined level, such as 5 percent, or within some other minimum allowable charge that would allow for recharging at a later time.

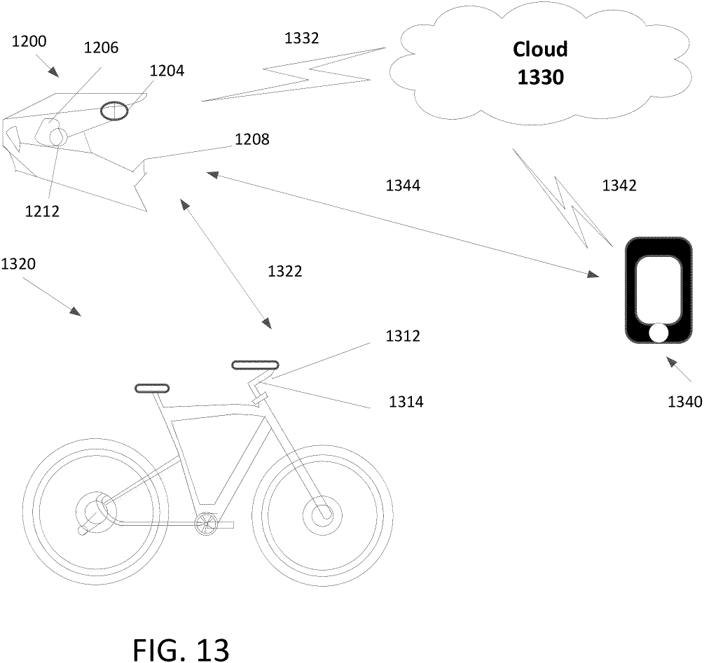

FIG. 13 illustrates a system that may include the cyclist’s helmet. Provided a cycling helmet 1200 that is configured with various electronic components, such as a microphone 1208, speakers 1212, a processing module 1206, etc., the helmet 1200 may communicate various data to and from the helmet 1200. In one embodiment, signals from sensors in the helmet 1200 may be transmitted to a cloud service 1330, via cellular communication 1332, and/or to a mobile device 1340, via WiFi or Bluetooth 1344. The mobile device 1340 may communicate with the cloud service 1330, via WiFi 1342, to obtain data regarding the cyclist and/or bike 1320. Information from bike censors may be transmitted from devices 1312, 1314 mounted to the bicycle 1320, to the helmet 1300, via Bluetooth 1322. For example, a performance bicycle 1320 may be configured with performance measurement components that provide performance data to a trip computer 1314. In one embodiment, the trip computer 1314 may communicate with the helmet 1200 and the helmet 1200 may be configured to speak the performance data through the speakers 1212. In addition, the helmet 1200 may be configured to transmit commands to the trip computer or other electronic devices 1312 mounted to the bicycle 1320. For example, the cyclist may speak a command, such as “power” to the microphone 1204 and the helmet processor 1206 may transmit a signal to the trip computer 1314, which responds with a signal 1322 for the power being exerted by the cyclist. The power reading may be output by the speakers 1212. For other electronic devices 1312, such as a light, which can be controlled by external signals, those devices may be controlled by a spoken command input to the microphone 1208. In some embodiments, the helmet 1200 may be configured to communicate with the mobile device 1340, for example, via Bluetooth, to perform as a device for receiving phone calls or text messages, and playing messages through the speakers 1212, as well as making calls or dictating messages through the microphone 1208. In the case of an emergency, a phone call may be made via a cellular connection 1232, or via the mobile device 1240, using a specific command, such as “emergency call.” Also, in a case that sensors in the helmet 1200, such as an accelerometer, indicate a possible accident, such as a fall or crash, the processor 1206 may be configured to automatically send an emergency signal 1332, or via the mobile device 1340, via signals 1344, 1342.

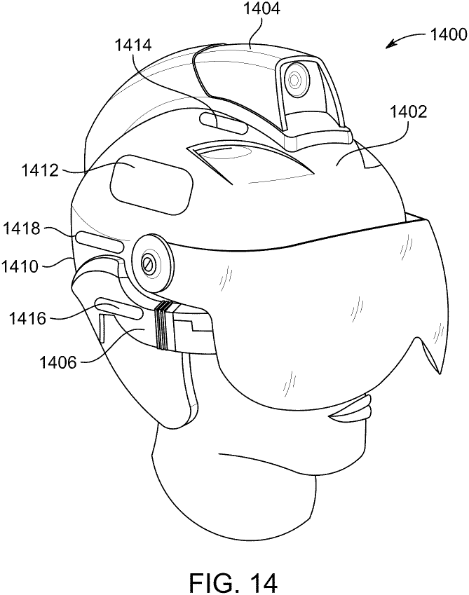

FIG. 14 illustrates a carbon fiber skiing helmet according to an embodiment of the disclosure. Similar to a cycling helmet, the primary function of a skiing helmet is for personal protection at the lightest weight. Referring to FIG. 14 the carbon fiber shell 1402 of a skiing helmet 1400 may be configured with a structural CF battery. In some embodiments, one or more sections of the carbon fiber shell 1402 may be configured with separate CF batteries 1412, 1414, 1416, 1418, sized to provide power for certain electronic components. In some embodiments, there may be several structural CF batteries of a predetermined size, or sizes, and interconnected in series or parallel to provide a required voltage or current. One or more embedded video cameras 1404 may be incorporated into an upper forward portion of the helmet 1400. A communication module 1406, such as Bluetooth and/or WiFi, may be incorporated into a side portion of the helmet 1400.

One or more connection ports 1410 may be included in the one or more sections of the carbon fiber shell that are configured as structural CF batteries. The connection ports are connected to a wired terminal 1002 of a respective section of the structural CF battery. The connection interfaces may be USB or micro USB ports.

Other types of sensors may be incorporated into the ski helmet 1400 that normally may have been prohibitive due to the requirement for additional batteries. Additional sensors that may be incorporated into the helmet 1400 may include a proximity sensor that detects when the helmet is being worn on the cyclists head, or has been removed, and an accelerometer that can detect motion of the helmet 1400. The sensors may be connected to a processor that is configured to determine an abrupt motion of the helmet 1400 while it is being worn by the cyclist, possibly indicating a collision or fall. The abrupt motion may include a sudden acceleration followed by a stop in motion or a reversed motion. The processor may be configured to send out a signal in the case of an indication of the possible collision or fall. Also, the video camera 1404 may be connected to the processor, which may control turning on and off the video camera in conjunction with the proximity sensor detecting that the helmet 1400 is on or off the cyclist’s head.

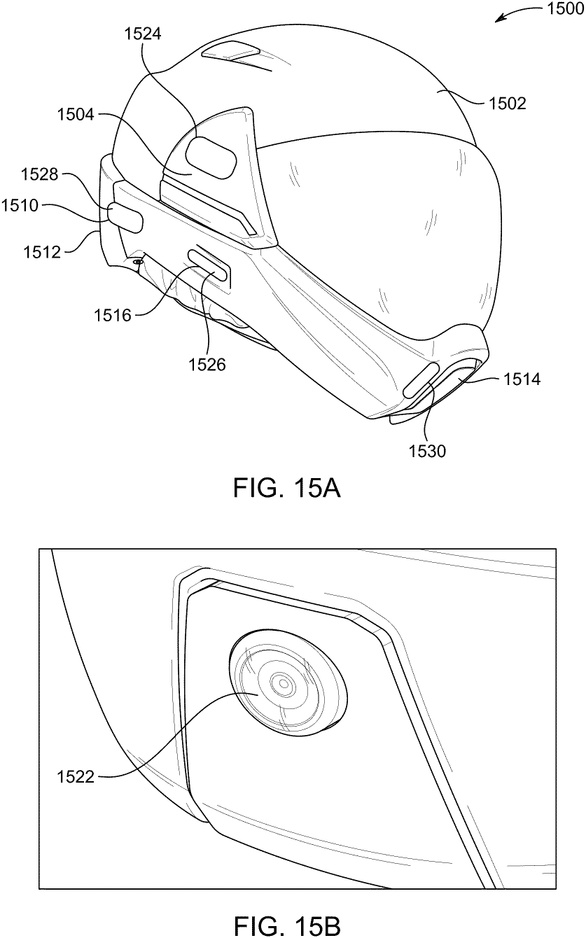

FIGS. 15A, 15B illustrates a carbon fiber motorcycle helmet according to an embodiment of the disclosure. Similar to a cycling helmet, the primary function of a motorcycle helmet is for personal protection at the lightest weight. Referring to FIG. 15A, a shell 1502 of a motorcycle helmet 1500 may be configured with a structural CF battery. In some embodiments, one or more sections of the shell 1502 may be configured with separate structural CF batteries 1524, 1526, 1528, sized to provide power for certain electronic components. In some embodiments, there may be several structural CF batteries 1524, 1526, 1528 of a predetermined size, or sizes, and interconnected in series or parallel to provide a required voltage or current. In some embodiments, the structural CF battery may be arranged as a sublayer below a protective cover 1110. The protective cover 1110 may be the carbon fiber shell 1502, or a fiber reinforced plastic. A processing module 1510, including a communication module such as Bluetooth and/or WiFi, may be incorporated into a rear portion or a side portion of the helmet 1500. In some embodiments, the motorcycle helmet 1500 may use the structural CF battery to supplement power that is generated by a primary internal battery, or as a backup for a primary internal battery when the primary battery reaches a state of charge that becomes at or below a predetermined level, such as 5%, or within some minimum allowable charge. In some embodiments, some electronic devices may be connected to the structural CF battery separately from devices that are powered by an internal rechargeable battery.

One or more electrical connection ports 1512 may be included in the one or more sections of the carbon fiber shell 1502 that are configured as structural CF batteries. The connection ports 1512 are connected to a wired terminal 1002 of a respective section of the structural CF battery. The connection ports 1512 may be USB or micro USB ports. In one or more embodiments, a single connection port 1512 may be included for recharging the structural CF battery. The structural CF battery may include multiple wired terminals 1002 for connection to one or more sensor devices.

Some types of sensors may be incorporated into the motorcycle helmet 1500 that normally may have been prohibitive due to the requirement for additional batteries. Sensors may be directly wired to a terminal 1002 of a structural CF battery without having to add a battery housing and a battery for powering the sensor. Additional sensors that may be incorporated into the helmet 1500 may include a proximity sensor that detects when the helmet is being worn on the motorcyclists head, or has been removed, and an accelerometer that can detect motion of the helmet 1500. The sensors may be connected to a processor (in an internal processing module 1510 located in a side or rear portion of the helmet 1500) that is configured to determine an abrupt motion of the helmet 1500 while it is being worn by the cyclist. The detection of an abrupt motion may be an indication of a possible collision or fall. An abrupt motion may be a sudden acceleration followed by a stop in motion, or a reversed motion, within a predetermined time period of the sudden acceleration. Since a motorcycle may be operated in a manner that includes acceleration and stop, the helmet 1500 may also include an attitude sensor such as a gyroscope, or inertial measurement unit. The processor may be configured to determine an abrupt motion that includes a change in attitude beyond a predetermined angle, in addition to an acceleration and abrupt stop in motion. The processor may be configured to send out a signal in the case of the indication of the possible collision or fall, as well as an indication of possible drowsiness through detection of the rider’s head falling below a certain angle while the motorcycle is in motion. The proximity sensor, accelerometer, gyroscope and/or inertial measurement unit, as well as the processor and a communication unit (in processing module 1510) may be directly connected to a structural CF battery by a wired terminal 1002 in order to output an emergency signal in the case of detection of one of the above emergency conditions.

Referring to FIG. 15B, a rear video camera 1522 may be connected to the processor, which may control turning on and off the video camera 1522 in conjunction with the proximity sensor detecting that the helmet 1500 is on or off the cyclist’s head. A section of the shell in the vicinity of the rear video camera may be configured as a structural CF battery dedicated to providing electric power for the rear video camera 1522.

In addition to sensors, the motorcycle helmet 1500 may include other electronic devices, such as a microphone 1514, speakers (inside the helmet 1500), and safety lights 1516. The motorcycle helmet 1500 may include an input device, such as a touch pad 1504. The touch pad 1504 may be configured with a tactile sensor. The microphone 1514 may be powered by a forward section of the helmet 1500, configured as a structural CF battery 1530 and that surrounds the microphone 1514.

The communication unit (in processing module 1510) may be connected to at least one of the speakers (inside the helmet 1500) and configured to communicate with external devices, such as a smartphone. Phone calls and text messages may be received through the smartphone and played through speakers in the module 1510 of helmet 1500. The touch pad 1504 may be used for inputting a command. The microphone 1514 may also be used for inputting a command, as well as answering a phone call. The processing module 1510 and touch pad 1504 may be powered by a section of the helmet shell 1502, configured as a structural CF battery 1528.

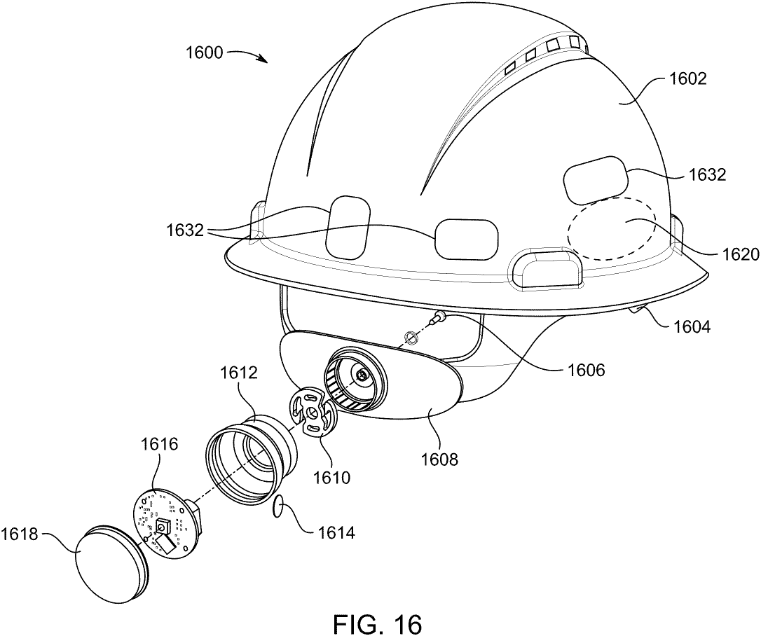

FIG. 16 illustrates a carbon fiber safety helmet according to an embodiment of the disclosure. Similar to a cycling helmet, the primary function of a safety helmet is for personal protection at the lightest weight. However, a carbon fiber reinforced resin hard hat may be constructed with a greater level of impact protection. The safety helmet 1600 includes a ratcheting fitment dial 1612 to adjust size of the strap. The ratcheting fitment 1612 is attached to a ratchet part 1610 by a washer and screw 1606. The ratcheting fitment 1612 may include a gas permeable part 1614. Referring to FIG. 16, the carbon fiber shell 1602 of a safety helmet 1600 may be configured with a structural CF battery. In some embodiments, a section of the carbon fiber shell 1602 may include a structural CF battery that is sized to provide power for one or more electronic components. In some embodiments, there may be several structural CF batteries 1632 of a predetermined size, or sizes, and interconnected in series or parallel to provide a required voltage or current. In some embodiments, the structural CF battery may be arranged as a sublayer below a protective cover 1110. The protective cover 1110 may be the carbon fiber shell 1602, or a fiber reinforced plastic. A communication module 1616 such as Bluetooth and/or WiFi, may be incorporated into a strap guide portion 1608 of the helmet 1600. The communication module 1616 may be covered by a closing cap 1618.

In some embodiments, the safety helmet 1600 may use the structural CF battery to supplement power that is generated by a primary internal battery, or as a backup for a primary internal battery when the primary battery reaches a state of charge that becomes at or below a predetermined level, such as 5%, or within some minimum allowable charge. In some embodiments, some electronic devices may be connected to the structural CF battery separately from devices that are powered by an internal rechargeable battery.

One or more electrical connection ports 1604 may be included in the section of the carbon fiber shell 1602 that is configured as a structural CF battery. The connection ports 1604 are connected to a wired terminal 1002 of the section of the structural CF battery. The connection ports 1604 may be USB or micro USB ports. In one or more embodiments, a single connection port 1604 may be included for recharging the structural CF battery. The structural CF battery may include multiple wired terminals 1002 for connection to various sensor devices.

Some types of sensors may be incorporated into the safety helmet 1600 that normally may have been prohibitive due to the requirement for additional batteries. Sensors may be directly wired to a terminal 1002 of a structural CF battery without having to add a battery housing and a battery for powering the sensor. Additional sensors that may be incorporated into the helmet 1600 may include a proximity sensor that detects when the helmet is being worn on the workers head, or has been removed, and an accelerometer that can detect motion of the helmet 1600. The sensors may be connected to a processor (in communication module 1616) that is configured to determine an abrupt motion of the helmet 1600 while it is being worn by the worker. The detection of an abrupt motion may be an indication of a possible collision or fall. The communication module 1616 may be configured to send out a signal in the case of the indication of the possible collision or fall. The proximity sensor, accelerometer, as well as the processor and a communication module 1616 may be directly connected to a structural CF battery by a wired terminal 1002 in order to output an emergency signal in the case of detection of one of the above emergency conditions.

Another possible sensor that may be incorporated is a temperature sensor. The communication module 1616 may be connected to the temperature sensor and configured to send out a signal in the case of a temperature above a threshold temperature.

The safety helmet 1600 may include speakers 1620 and a microphone. The communication module 1616 may be configured to communicate with external devices, such as a smartphone or other portable communications unit. Phone calls and text messages may be received through the smartphone and played through the speakers 1620 of safety helmet 1600.

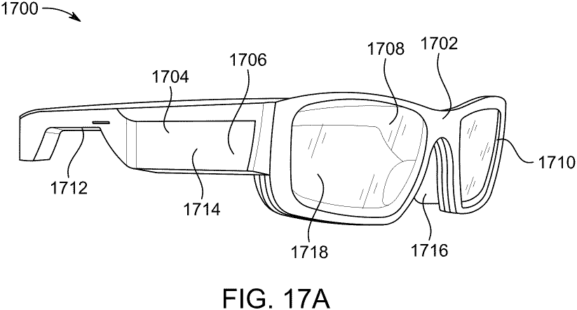

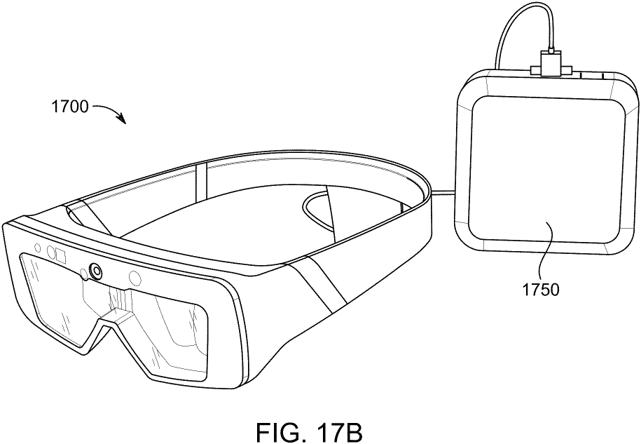

FIGS. 17A, 17B are a schematic of smart glasses according to an embodiment of the disclosure. It is highly desirable that smart glasses be functional for the most time possible between charges. However, smart glasses 1700 typically include a processor and several sensors and other electronic devices. A battery is typically mounted to the rear of the frame, positioned just behind the ear when worn on a head. An example of conventional smart glasses has a 470 mAH internal battery that is designed to last 1-2 hours. A heavier battery in the rear frame position can become uncomfortable. Placing a battery at the forward part of the frame can lead to unbalanced weight and a tendency for classes to slide down the nose bridge of a user. One option is a power bank that is worn around the neck to comfortably and conveniently extend the run time of the glasses. Another option is a battery that may be swapped without powering down the smart glasses. As shown in FIG. 17B, a further option is a portable battery pack 1750 that is connected to the smart glasses 1700. The portable battery pack 1750 may include a clip to attach to a belt.

Smart glasses 1700 include video processing capability that facilitates display of images within the lenses. The smart glasses 1700 typically include a communications module for communication with an external device. Some smart glasses 1700 include a camera and microphone. As such, smart glasses 1700 range in function from augmented reality (AR), virtual reality (VR), and mixed reality (MR) in gaming, entertainment, industrial applications, to communications and image recognition. For example, smart glasses 1700 may be used for texting, checking appointments, taking pictures with voice or touch commands, take calls, check messages, listen to music, and receive calendar alerts, to name a few.

Referring to FIG. 17A, smart glasses 1700 may be configured with a display processing engine and communications module 1714, full color display 1718, camera 1710, which can include a HD camera and HD camera with autofocus, stereo speakers 1712, microphone 1716. The communications module 1714 may include wireless WiFi and Bluetooth. Smart glasses 1700 may include a touch pad 1704 located along one of the rims of the frame 1702. Smart glasses 1700 may include at least one USB/micro USB connection 1708.

The smart glasses 1700 may be controlled by voice control, gestures applied to the touch pad, as well as head motion tracking. In some cases, the smart glasses 1700 may work in conjunction with a smartphone by way of a mobile application (remote control App).

In disclosed embodiments, the weight and balance of smart glasses 1700 may be improved, and/or the time between recharging may be extended, by incorporating all or a portion of the frame with a structural CF battery. In particular, internal rechargeable batteries of conventional smart glasses may be replaced through configuration of the frame 1702 of the glasses as a structural CF battery. In some embodiments, the internal rechargeable batteries may be supplemented with a structural CF battery and/or the internal rechargeable batteries may be reduced in size. In one or more embodiments, a single connection interface 1708 may be included for recharging the structural CF battery. The structural CF battery may include multiple wired terminals 1002 for connection to various devices including one or more of display processing engine 1714, speakers 1712, camera 1710, and microphone 1716. In some embodiments, one or more electrical connection ports 1708 may be included in the one or more sections of the carbon fiber frame 1702 that are configured as structural CF batteries. The connection ports 1708 may be connected to a wired terminal 1002 of a respective section of the structural CF battery.

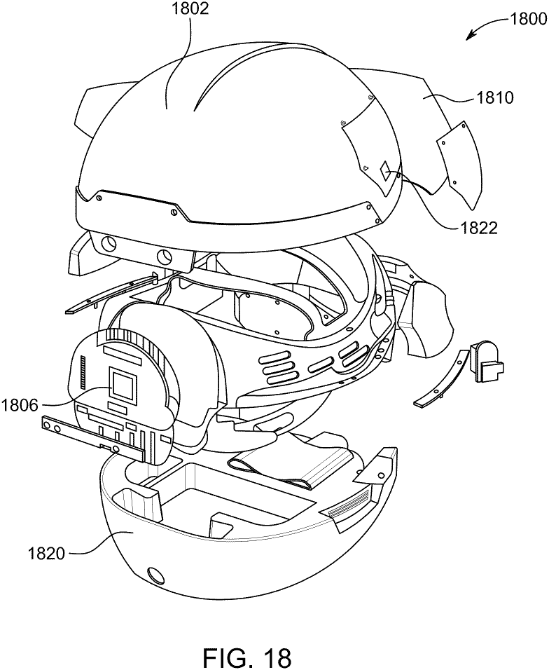

FIG. 18 is a schematic of smart helmet according to an embodiment of the disclosure. A smart helmet may include a greater amount of carbon fiber in a carbon fiber shell than smart glasses 1700. Internal rechargeable batteries of a conventional smart helmet may be omitted through configuration of the carbon fiber shell 1802 as a structural CF battery. The structural CF battery 1802 may have a power capacity that is greater than the internal rechargeable batteries of a conventional smart helmet. The display area of a display screen may be substantially larger than in smart glasses 1700. In some embodiments, there may be several structural CF batteries of a predetermined size, or sizes, and interconnected in series or parallel to provide a required voltage or current.

The helmet may include four cameras to help in assessing problems in the field by sending video in real-time to a technician in an office who can view what the on-site worker is seeing. The helmet may remotely direct a worker through a repair job. The technician in the office can see what the worker is seeing, and circle the problem areas and explain to the worker, through the helmet’s speakers, what needs to be done to repair and how to perform the repair. The helmet may include a camera that can perform thermal imaging.

Referring to FIG. 18, the smart helmet 1800 may include a processor circuit board 1806 mounted to the back of the smart helmet. The smart helmet 1800 may include a docking and charging station 1820 for recharging the battery for the smart helmet 1800. The smart helmet 1800 may include a display system 1810 and connection ports 1822 for connecting to external devices.

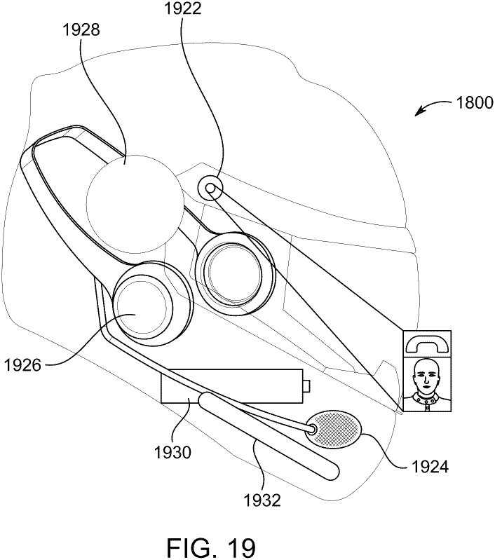

FIG. 19 is a schematic of the interior of a smart helmet according to an embodiment of the disclosure. The smart helmet 1800 may be configured internal electronic devices, such as a mini projector 1922 for projecting a head up display to a display screen. Internal electronic devices may include sound devices. For sound, there may be microphones 1924, volume and power buttons and a sound output jack or built-in headphones 1926. A touch panel 1928 may be included on one side of the smart helmet 1800 as an input device for receiving gestures as input commands. The touch panel 1928 may include a sublayer of a structural CF battery to provide power to the touch panel. The smart helmet 1800 may include a vision system having at least one camera 1930 as a vision sensor for capturing video. Each camera 1930 may be connected to a local structural CF battery 1932 within the helmet shell as a source of power for each respective camera 1930.

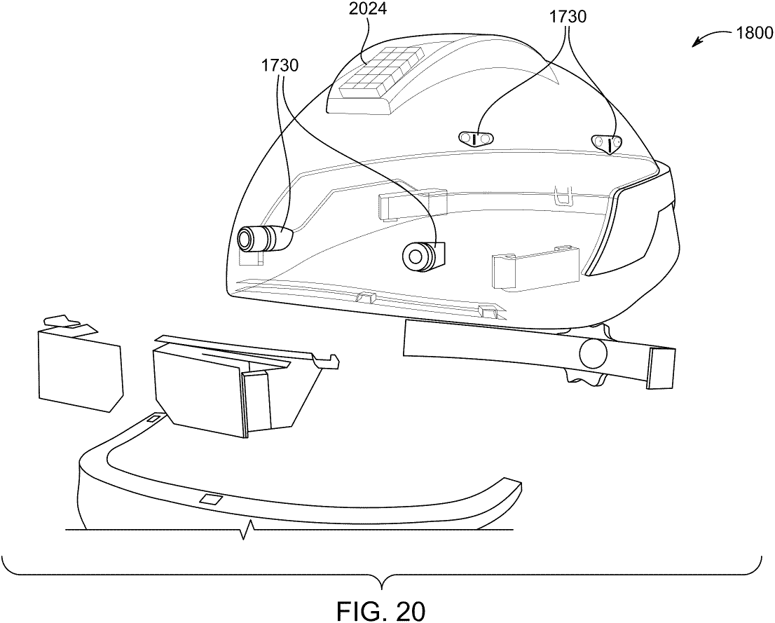

FIG. 20 illustrates location of cameras for a smart helmet according to an embodiment of the disclosure. The smart helmet 1800 may include multiple cameras 1930. The multiple cameras 1930 include a HD camera to capture videos and photos, track objects and recognize 2D targets and colors. A vision system includes two infrared cameras built in, and integrated with an infrared laser projector that can sense depth by measuring deflected infrared light. A low-resolution camera is integrated with an industrial-grade inertial measurement unit 2024 (IMU), which allows the helmet to compute its relative position in space in real time via a combination of gyroscopes and accelerometers.

FIG. 21 is a schematic of a wireless headphone according to an embodiment of the disclosure. Typically, a battery is required to power the wireless communication of the wireless headphone 2100. Some wireless headphones have a battery life of about 24 hours with noise cancellation, and longer life with noise cancellation turned off. Some wireless headphones include rechargeable batteries and may include fast recharging capability. In any case, long battery life between recharging is an important feature, especially when the headphones include noise cancellation and an optional microphone.

In one embodiment, the battery (e.g., coin battery, lithium polymer battery, lithium ion battery) included in the wireless headphone 2100 may be supplemented with at least one structural CF battery. The headpiece 2102 for the headphones may include an outer layer that is configured as a structural CF battery. In addition, an earpiece 2104 may be configured as a structural CF battery. The at least one structural CF battery may be used to power one device, while the included battery may power other devices. For example, a structural CF battery may be used to power the Bluetooth communications circuit, while the included battery may power the noise cancellation function. Alternatively, the powering may be reversed such that the Bluetooth communications circuit may be powered by the included battery whereas the structural CF battery may power the noise cancellation function.

One alternative, may be to use a structural CF battery as an auxiliary power source to backup the included battery. When the included battery reaches a certain level of state of charge, the structural CF battery may provide power for the wireless headphone 2100 to extend the time between recharging.

In one embodiment, a battery (e.g., lithium polymer battery, lithium ion battery) and its associated housing is replaced with circuitry for an additional sensor connected to the communication circuitry. For example, a proximity sensor may be mounted in the headphone in order to detect when the headphone is being worn, or has been removed from a user’s head. Alternatively, or in addition, an accelerometer may be mounted in the headphone in order to detect when the headphone is moving or is stationary. The additional sensors and communication circuitry for the headphone are powered by an earpiece 2104 configured as a structural CF battery. A connection port, such as a USB port or micro USB port, may be connected to a terminal 1002 in order to recharge the structural CF battery.

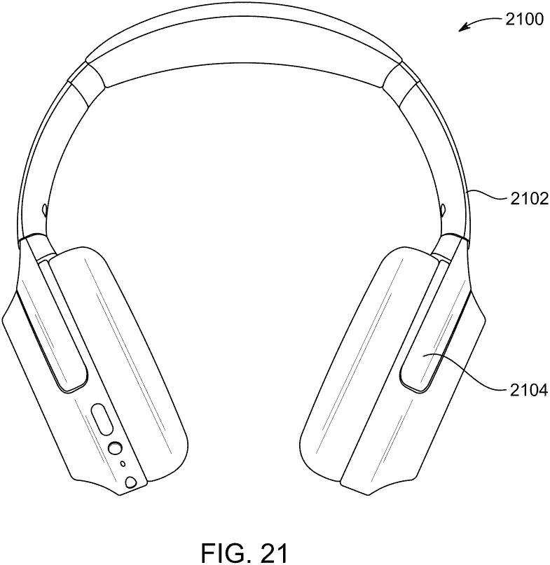

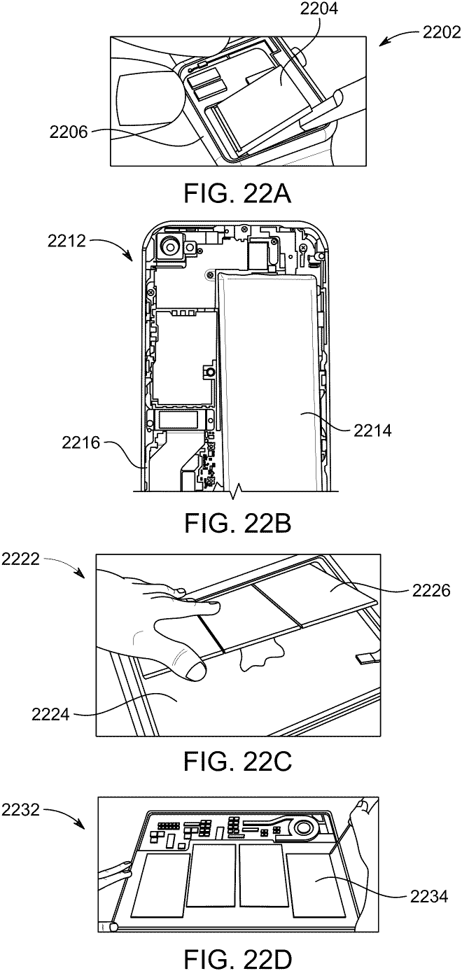

FIGS. 22A, 22B, 22C, 22D are exemplary battery operated mobile (carriable/portable) devices that can include carbon fiber batteries. FIG. 22A is an exemplary smart watch 2202 showing its watch battery. FIG. 22B is an exemplary smartphone 2212 showing its internal battery. FIG. 22C is an exemplary tablet computer 2222 showing its internal battery. FIG. 22D is a laptop computer 2232 showing its internal battery. The watch battery 2204 makes up approximately 50% of the total weight of the watch. The tablet internal battery 2224 makes up approximately 32% of the total weight. The laptop internal battery 2234 makes up approximately 20% of total weight.

Smartphones have preferred physical sizes for handheld uses. However, newer models include additional and more powerful features. In one example, a smartphone 2212 includes a higher refresh rate screen, an extra GPU core, and more cameras that a previous smartphone model. The lithium polymer battery 2214 of a smartphone 2212 is restricted in size in order to accommodate for additional features.

There is a need to maintain or increase battery life in mobile devices in conjunction with increasing features. Additional features generally demand more battery power. In an embodiment, a backing case 2206 of the smart watch 2202 may be formed as a structural CF battery. In an embodiment, a backing case 2216 of a smartphone 2212 may be formed as a structural CF battery. In an embodiment, a back panel 2226 of a tablet computer 2222 may be formed as a structural CF battery. In an embodiment, a backing case of a laptop computer 2232 may be formed as a structural CF battery. In each case, the addition of a structural CF battery can supplement an internal battery of a mobile device and serve as an avenue for increased power. In some embodiments, there may be several structural CF batteries of a predetermined size, or sizes, and interconnected in series or parallel to provide a required voltage or current. The structural CF battery can be configured with a wired terminal 1002 that may be connected to the same charging port as the internal battery, or may be connected to the wireless charging coil of the internal battery. In a case of wireless recharging, the structural CF battery may have its own terminal coil 1004.

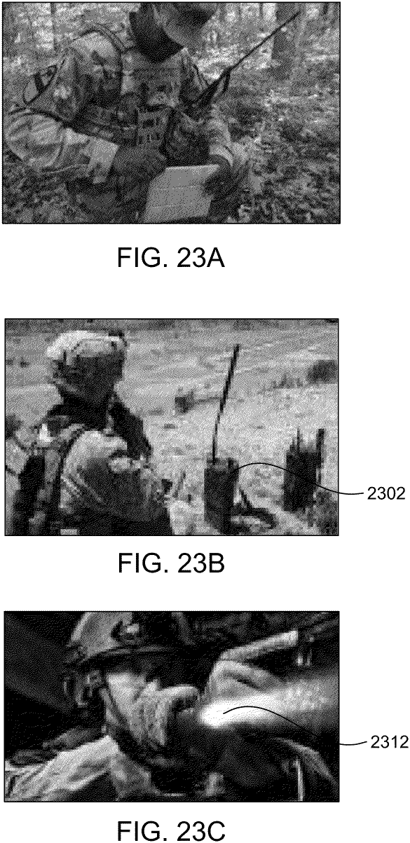

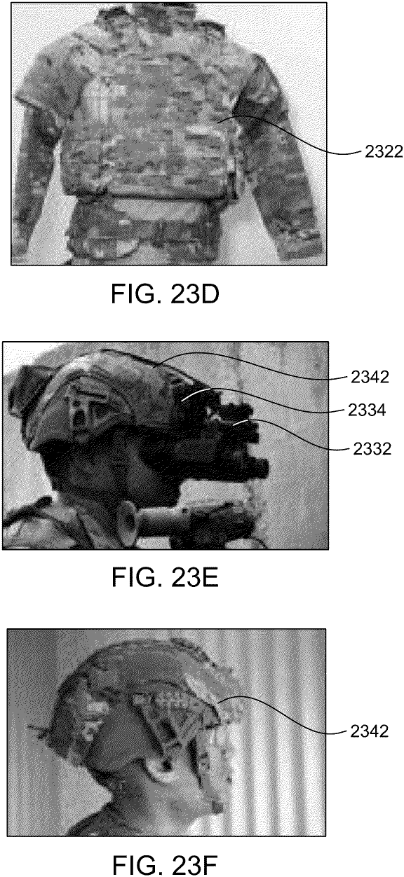

FIGS. 23A to 23F are examples of military devices and armor that can include carbon fiber batteries. More and more electronic military devices are being carried by solders in the field to perform their mission. A typical solder may carry an average of about 20 pounds of batteries for a 72 hour mission. Military equipment that may be carried may include a portable communication radio 2302, FIG. 23B, a flashlight 2312, FIG. 23C, and night vision gear 2332, FIG. 23E. In addition, solders may be outfitted with armor for personal protection, such as armored clothing 2322, FIG. 23D, and a helmet 2342, FIG. 23F.

Regarding FIG. 23B, at least a portion of the portable communication radio 2302 may be formed as a structural CF battery. The structural CF battery may be used to supplement the radio internal battery, or may replace the radio internal battery in order to reduce weight of the portable communication radio 2302. Regarding FIG. 23C, the casing of a flashlight 2312 may be formed as a structural CF battery. The flashlight 2312 having the structural CF battery is rechargeable and can be recharged either by way of an external connection port, e.g., USB or micro USB, or wirelessly by way of a coil 1004. Regarding FIG. 23E, the night vision gear 2332 may be configured with a casing formed as a structural CF battery. The structural CF battery may be used to supplement the vision gear internal battery, or may replace the vision gear internal battery in order to reduce weight. The helmet 2342 and night vision gear 2332 may be configured with a mounting structure 2334 for mounting a housing of the night vision gear 2332 to the helmet 2342. The mounting structure 2334 may include an electrical connection port, such as a USB port or micro USB port, or other suitable electrical connection port. The electrical connection port may be connected to at least one external connection port of the helmet 2342.

Armored clothing 2322 may include a layer, or layers, or sections, formed as a structural CF battery. The layer of structural CF battery may include a terminal 1002 for recharging the battery, as well as a terminal for connection to external devices. The terminal 1002 for connection to external devices may be connected to a standard connection port, such as USB or micro USB, into which an external device, such as the portable communication radio 2302, flashlight 2312, or night vision gear 2332, may be connected for recharging.

A helmet 2342 may include a shell layer, sublayers, or portion, formed as a structural CF battery. The structural CF battery of the helmet 2342 may include one of more terminals 1002 for connection to external devices, by way of a connection port, such as a connection port for powering the night vision gear 2332. In addition, a connection port, such as USB or micro USB, may be included for recharging the structural CF battery of the helmet 2342.

The above description is presented to enable a person skilled in the art to make and use the embodiments and aspects of the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. In this regard, certain embodiments within the disclosure may not show every benefit of the disclosure, considered broadly.

1. An electric power storage device, comprising:
a protective cover configured to protect from impact including at least one electric carbon fiber component;
the at least one electric carbon fiber component incorporating a structural battery, the structural battery including one or more energy storage devices,
each of the one or more energy storage devices having:
at least one anode core of a continuous carbon fiber,
an electrolyte arranged on the at least one continuous carbon fiber core, and
a cathode layer arranged to the at least one continuous carbon fiber core on the electrolyte; and
at least one interface terminal electrically connected to the structural battery, the at least one interface terminal for outputting power from the structural battery.

2. The electric power storage device of claim 1, wherein
each of the one or more energy storage devices having a laminate structure with:
at least one anode core of a plurality of continuous carbon fibers,
an electrolyte coating arranged on the plurality of continuous carbon fibers, and
a cathode layer arranged to the at least one continuous carbon fiber core on the electrolyte coating.

3. The electric power storage device of claim 1, wherein the protective cover comprises an outer protective material shell arranged over the at least one carbon fiber component arranged as a sublayer.

4. The electric power storage device of claim 2, wherein the outer protective material shell is of glass fiber reinforced nylon.

5. The electric power storage device of claim 1, wherein the protective cover comprises a carbon fiber reinforced resin shell, and
wherein the carbon fiber reinforced resin shell is arranged over the at least one carbon fiber component arranged as a sublayer.

6. The electric power storage device of claim 1, further comprising:
a motion detection sensor,
wherein the motion detection sensor is connected to the interface terminal for powering the motion detection sensor.

7. The electric power storage device of claim 6, further comprising:
a wireless communications unit,
wherein the wireless communications unit is connected to the interface terminal for powering the wireless communications unit, and
wherein the wireless communication unit is configured to output a signal based on detection of a predetermined motion by the motion detection sensor.

8. The electric power storage device of claim 6, wherein the motion detection sensor is an accelerometer.

9. The electric power storage device of claim 8, wherein the accelerometer is configured to detect an acceleration motion followed by an abrupt stop or reversal in motion direction.

10. The electric power storage device of claim 7, wherein the wireless communication unit is further connected to a microphone,
wherein the microphone is connected to the interface terminal for powering the microphone.

11. The electric power storage device of claim 1, further comprising:
at least one camera,
wherein the at least one camera is connected to the interface terminal for powering the at least one camera.

12. The electric power storage device of claim 1, further comprising:
one or more speakers with noise cancellation circuitry,
wherein the noise cancellation circuitry is connected to the interface terminal for powering the noise cancellation circuitry.

13. The electric power storage device of claim 1, further comprising a lithium polymer battery,
wherein the output power of the structural battery supplements electric power that is output by the lithium polymer battery.

14. The electric power storage device of claim 1, further comprising a lithium ion battery,
wherein the output power of the structural battery supplements electric power that is output by the lithium ion battery.

15. The electric power storage device of claim 1, further comprising a lithium polymer battery,
wherein the output power of the structural battery is backup power for when the lithium polymer battery reaches a state of charge below a predetermined level.

16. The electric power storage device of claim 1, further comprising a touch pad having a tactile sensor and mounted to a side of the protective cover,
wherein the touch pad is connected to the interface terminal for powering the tactile sensor.

17. The electric power storage device of claim 1, further comprising multiple sensors including a proximity sensor for detecting when the protective cover is being worn,
wherein the proximity sensor is configured to turn off others of the multiple sensors when the proximity sensor does not detect that the protective cover is being worn, and
wherein the proximity sensor is connected to the interface terminal for powering the proximity sensor.

18. The electric power storage device of claim 17, further comprising a primary battery,
wherein the others of the multiple sensors are powered by the primary battery.

19. The electric power storage device of claim 1, further comprising:
a mounting structure for mounting a housing of an external electric device,
wherein the mounting structure includes an electrical connection port, and
wherein the electrical connection port is connected to the at least one interface terminal.

20. An electric power storage device, comprising:
a head mountable frame including at least one electric carbon fiber component;
the at least one electric carbon fiber component incorporating a structural battery, the structural battery including one or more energy storage devices,
each of the one or more energy storage devices having:
at least one anode core of a continuous carbon fiber,
an electrolyte arranged on the at least one continuous carbon fiber core, and
a cathode layer arranged to the at least one continuous carbon fiber core on the electrolyte;
a vision system mounted in the frame and having at least one sensor;
at least one interface terminal electrically connected to the structural battery, the at least one interface terminal connected to the at least one sensor for powering the at least one sensor by the structural battery; and
a head-up display and a display processing engine,
wherein the head-up display is projected by a projector.
